(19) United States
(12) Patent Application Publication
(10) Pub. No.: US 2024/0013165 A1
(43) Pub. Date: Jan. 11, 2024

(54) Systems and Methods for Optimizing Monetization Opportunities for Climate-Change-Related Program Benefits

(71) Applicant: Locus Solutions IPCo., LLC, Solon, OH (US)

(72) Inventor: Karthik N. KARATHUR, Solon, OH (US)

(21) Appl. No.: 17/771,729

(22) PCT Filed: Oct. 29, 2021
(86) PCT No.: PCT/US2021/057222

§ 371 Date: Apr. 25, 2022

Related U.S. Application Data
(60) Provisional application No. 63/108,393, filed on Nov. 1, 2020.

(51) Int. Cl. G06Q 10/30; G06Q 50/02

(52) U.S. Cl. CPC G06Q 10/30; G06Q 50/02

(57) ABSTRACT

Systems and methods for analyzing monetization opportunities for climate-change-related program benefits and providing optimal combinations of program options to maximize monetization in an agricultural setting are provided. The system can work directly with a user's existing data management system and provide an automated service to optimize monetization of program benefits to give an additional revenue stream to the user.

### CROSS REFERENCE TO RELATED APPLICATION

This application claims priority to U.S. Provisional Patent Application No. 63/108,393, filed Nov. 1, 2020, which is incorporated herein by reference in its entirety.

### BACKGROUND OF THE INVENTION

Climate change is an issue that has gained much attention. The 2019 United Nations Environment Program stated that if emissions can be reduced by 7.6% annually, the world can avoid exceeding the 1.5° C. global temperature increase threshold. Industrial agriculture causes between 11-33% of global greenhouse gas (GHG) emissions and is therefore one of the focal points for new solutions to reducing emissions. FIG. 2 is a pie chart showing a breakdown of sources of climate change-related emissions related to food, and FIG. 3 is a pie chart showing a breakdown of contributors to agricultural greenhouse gases. Many technologies in development aim to mitigate future emissions but do not remove carbon already in the atmosphere, leaving a need for carbon sequestration tools.

Agriculture land occupies more than a quarter of total land area on earth and can be a critical part of climate change solutions because of its scale. FIG. 4 provides a visualization of the proportions of land to the earth's surface, habitable land to total land, agricultural land to habitable land, and livestock and corn to agricultural land, respectively from the top row to the bottom row. When done correctly using regenerative agricultural practices and other green technologies, a net sequestration of carbon into the soil can be achieved. This can remove carbon from the atmosphere and make the soil healthier and more productive. Also, about 55% of agriculture-related emissions are from enteric livestock methane emissions and manure tailing ponds. Any reduction in these emissions can therefore help reduce the carbon footprint of agricultural land.

Moving agriculture in a direction to lower the carbon footprint, or in a “greener” direction, has been advanced recently in many parts of the world, including the United States of America and in countries of the European Union (EU). This has been incentivized through international cap and trade mechanisms and carbon markets. Agriculture-related carbon removal and mitigation projects continue to be considered for inclusion into cap and trade mechanisms, which reward green projects financially. FIG. 5 shows a map of regional, national, and subnational carbon pricing initiatives, and FIG. 8 shows a table of carbon pricing by year, with expected costs through 2050 included.

The Growing Climate Solutions Act of 2020 has been proposed in the United States Congress and would include The United States Department of Agriculture (USDA) utilizing a website to provide guidance, technical assistance providers (TAPs) certified by the USDA with agriculture or forestry expertise to work with farmers to design and implement projects that can produce a tradeable carbon credit, and third-party verifiers certified by the USDA to confirm that emissions were reduced or carbon was stored. Farmers can obtain carbon credits to provide new revenue streams by funding climate-smart agriculture and forestry practices (see also FIG. 6). This is helpful as farmers are in need of extra capital to implement climate-smart agriculture and forestry practices. The European Green Deal in the EU budget for 2021-2027 calls for 40% of the common agricultural policy budget to contribute to climate action and 30% of the maritime fisheries fund to contribute to climate objectives. The European Green Deal also aims to ensure affordable and sustainable food is obtainable, climate change is addressed, the environment is protected, biodiversity is preserved, and organic farming is increased (see also FIG. 7).

There has also been an increasing demand recently from corporations for carbon solution, and over 20 countries have committed to becoming carbon neutral by 2050. FIG. 9 shows how the number of countries and corporations with climate-change-related goals has increased just from 2016 to 2019. A variety of offset programs and trading platforms have been developed to meet demand, with FIG. 10 showing examples of voluntary programs. There are also government-mandated programs in some states of the United States, including Ohio, Virginia, and North Carolina. In addition to these offset programs, there are also programs such as low carbon fuel systems (LCFSs) that impact farmers indirectly.

### BRIEF SUMMARY OF THE INVENTION

In view of the myriad of program options available, farmers and other agricultural and forestry professionals need assistance navigating through these options and obtaining maximum value from cap and trade mechanisms, carbon markets, regulatory programs, and other incentives available for emissions reduction and/or removal. Many of the programs have clauses around rules of participation, including exclusionary requirements (i.e., participating in one program may preclude participation in other programs, even those yet to be established, and possibly for lengthy periods of time). In addition, the requirements for monetization are normally stated in the methodology referred to by each organization or group providing the platform for monetization, but these methodologies can sometimes be different even for the same environmental benefit.

Given these complexities, it is unlikely that a farmer or other agricultural or forestry professional would have the capability and/or capacity to make a proper determination on an optimal combination of program options to offer maximal value. Data Service Consultancy Firms may attempt to assist with such a determination, but even they will be unlikely to arrive at an optimal combination of program options, and they will also impose significant costs to farmers and other agricultural and forestry professionals. Embodiments of the subject invention can work with a farmer's (or other agricultural or forestry professional's) data management system and provide an automated service to give insight into: value of opportunities in a visual format; taking care of bookkeeping requirements and data pulls and organization to support monetization, so that the process is as quick and painless as possible; and how to maximize returns from environmental benefits monetization. Systems and methods of embodiments of the subject invention can therefore provide farmers with a substantial second revenue stream from emissions reduction program benefits.

In an embodiment, a system for optimizing monetization opportunities for climate-change-related program benefits for an agricultural site can comprise: a processor; and a machine-readable medium in operable communication with the processor and an agriculture data management system of the agricultural site, the machine-readable medium having instructions stored thereon that, when executed by the processor, perform the following steps: collecting, from at least one regulatory or government information source, first data about the climate-change-related program benefits, the climate-change-related program benefits being based on the geographical location of the agriculture site; collecting, from the agriculture data management system, second data about the agricultural site; analyzing the first data and the second data to determine the climate-change-related program benefits for which the agricultural site is eligible; running an optimization process on the first data and the second data to determine an optimum combination of climate-change-related program benefits for the agricultural site to maximize monetization of available climate-change-related program benefits; and utilizing blockchain to publicly post transactions from the optimum combination of climate-change-related program benefits. The climate-change-related program benefits can comprise benefits related to carbon sequestration, nitrogen use reduction, phosphorous use reduction, soil nitrous oxide flux reduction, energy/fuel use reduction, enteric methane reduction, and/or reduction of methane from tailing ponds. The agricultural site can be, for example, a farm. The system can further comprise a display and a graphical user interface (GUI) via which a user can view results and enter information. The second data can also collected from satellite soil organic carbon (SOC) imagery of the agricultural site, crop insurance filings of the agricultural site, an agriculture SOC database, equipment software of the agricultural site, accounting software of the agricultural site, a livestock data management tool of the agricultural site, and/or remote sensing satellite imagery of the agricultural site. The first data about the climate-change-related program benefits can comprise information about county-level, state-level, national-level, and/or international-level climate-change-related program benefits. The system can communicate with a carbon market. The system can comprise at least one application programming interface (API) to obtain the first data and/or second data from each source, respectively. The at least one regulatory or government information source can comprise a regulatory or government server, a regulatory or government website, or both. The instructions when executed by the processor can further initiate a practice change impact dashboard in which a user can utilize a physical user interface to provide input and view different scenarios based on the provided input via a graphical user interface on a display of the system.

In another embodiment, a method for optimizing monetization opportunities for climate-change-related program benefits for an agricultural site can comprise: collecting, from at least one regulatory or government information source, first data about the climate-change-related program benefits, the climate-change-related program benefits being based on the geographical location of the agriculture site (the collecting of the first data can be performed by, for example, a processor in operable communication with an agriculture data management system of the agricultural site; collecting (e.g., by the processor), from the agriculture data management system, second data about the agricultural site; analyzing (e.g., by the processor) the first data and the second data to determine the climate-change-related program benefits for which the agricultural site is eligible; running (e.g., by the processor) an optimization process on the first data and the second data to determine an optimum combination of climate-change-related program benefits for the agricultural site to maximize monetization of available climate-change-related program benefits; and utilizing (e.g., by the processor) blockchain to publicly post transactions from the optimum combination of climate-change-related program benefits.

### BRIEF DESCRIPTION OF THE DRAWINGS

FIG. 1 is a block diagram of a system for analyzing monetization opportunities for climate-change-related program benefits and providing optimal combinations of program options to maximize monetization, according to an embodiment of the subject invention.

FIG. 2 is a pie chart showing a breakdown of sources of climate change-related emissions related to food.

FIG. 3 is a pie chart showing a breakdown of contributors to agricultural greenhouse gases.

FIG. 4 is a chart showing the proportions of land to the earth's surface (top row), habitable land to total land (second row), agricultural land to habitable land (third row), and livestock and corn to agricultural land (fourth row).

FIG. 5 is a map showing regional, national, and subnational carbon pricing initiatives.

FIG. 6 is a visualization of features of the Growing Climate Solutions Act of 2020.

FIG. 7 is a visualization of features of the European Green Deal.

FIG. 8 is a table of carbon pricing by year, with expected costs through 2050 included.

FIG. 9 is a chart of the number of countries and corporations with climate-change-related goals in 2016 and 2019

FIG. 10 is a visualization of voluntary offset programs.

FIG. 11 is an image of remote sensing satellite imagery showing soil organic carbon (SOC) levels for 2017, 2018, and 2019 for a particular area.

### DETAILED DESCRIPTION OF THE INVENTION

The subject invention provides novel and advantageous systems and methods for analyzing monetization opportunities for climate-change-related program benefits and providing advantageous combinations of program options to improve monetization in an agricultural (and/or forestry) setting.

The systems and methods of the subject invention can work directly with a farmer's (or other agricultural or forestry professional's) data management system and provide an automated service to give insight into: value of opportunities in a visual format; taking care of bookkeeping requirements and data pulls and organization to support monetization, so that the process is as quick and painless as possible; and how to maximize returns from environmental benefits monetization. This can provide farmers (and/or other agricultural and/or forestry professionals) with a substantial second revenue stream from climate-change-related (e.g., carbon emissions reduction and/or removal) program benefits.

The systems and methods of embodiments of the subject invention can comprise a blockchain-based platform that provides public recording of transactions (e.g., to ensure that the same claims are not sold multiple times), data privacy, and the ability to potentially be an inset-offset exchange by itself (due to the blockchain design). The platform can have knowledge of what monetization opportunities exist at the county, state, regional, national, and/or international levels based on the location of the field blocks of the agricultural setting for which the platform is optimizing monetization. That is, the data can be location-based. This knowledge can come from communicating with government and/or regulatory agency servers, websites, or other data locations that provide information on the monetization opportunities. This knowledge can alternatively or additionally be entered manually by a user of the platform and/or be pulled from the local agriculture data management system. The platform can include a practice change impact dashboard that visually provides insight into what additional practice changes can achieve maximum impact. A net benefit determination can be provided that takes into account costs required to make the practice changes. The maximum optimized benefit can be provided, as well as the ability to investigate additional scenarios (e.g., enter in alternative and/or additional changes manually) to determine other benefit totals. The platform can also provide hassle-free click-through by automatically pulling the required data from the different available sources for each type of program benefit to apply for, thereby taking away the hassle of understanding requirements for such program benefits. The data records can be pulled and complied to be presented in a clean and easy to understand manner. If the required data is not available to be pulled by the platform of the system/method, the platform can provide guidance on where the user can obtain it.

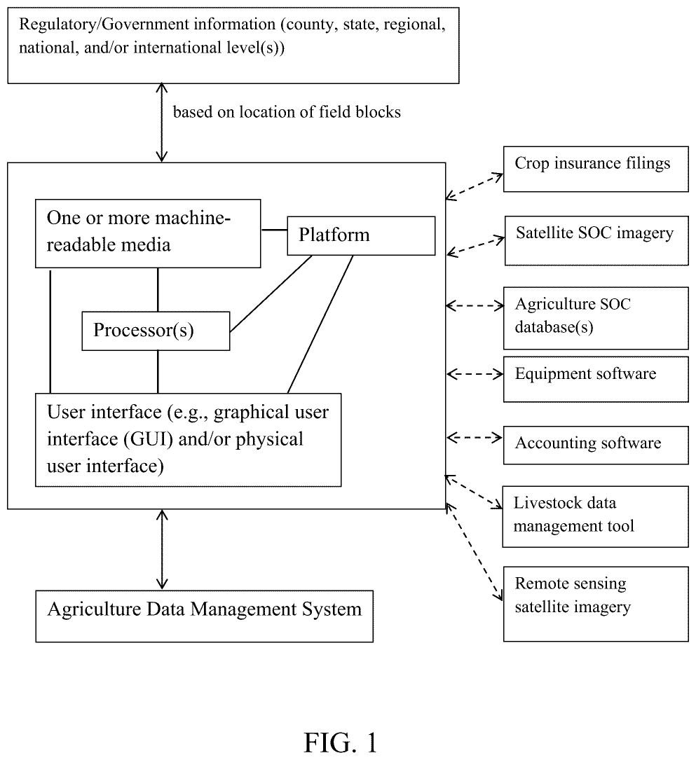

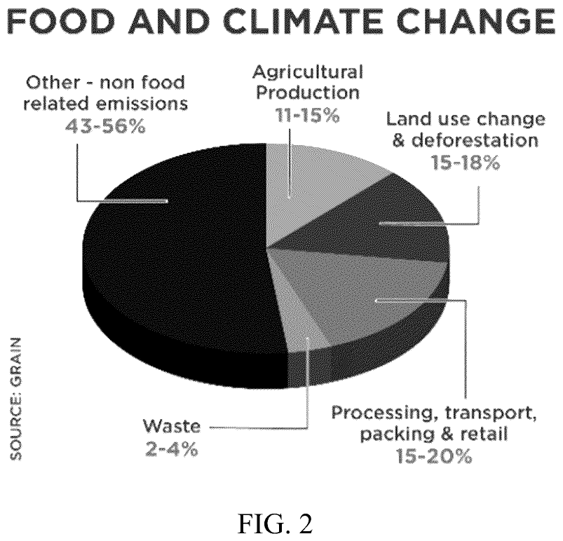

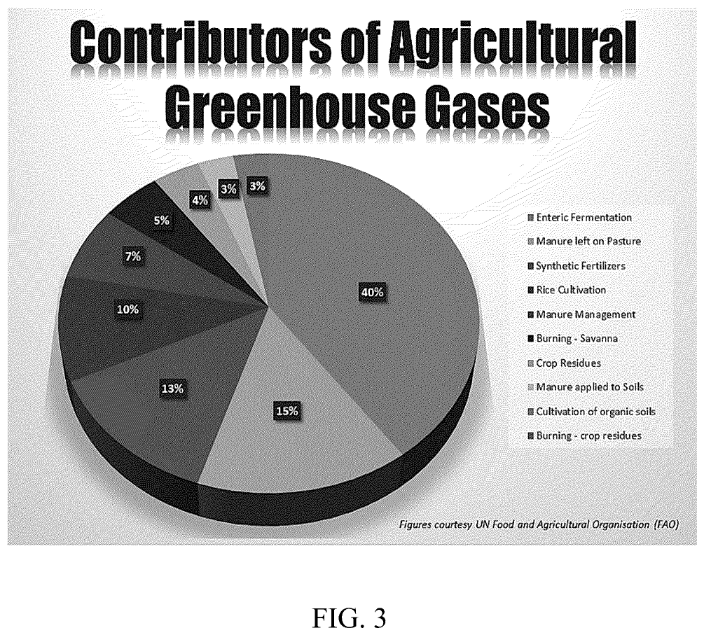

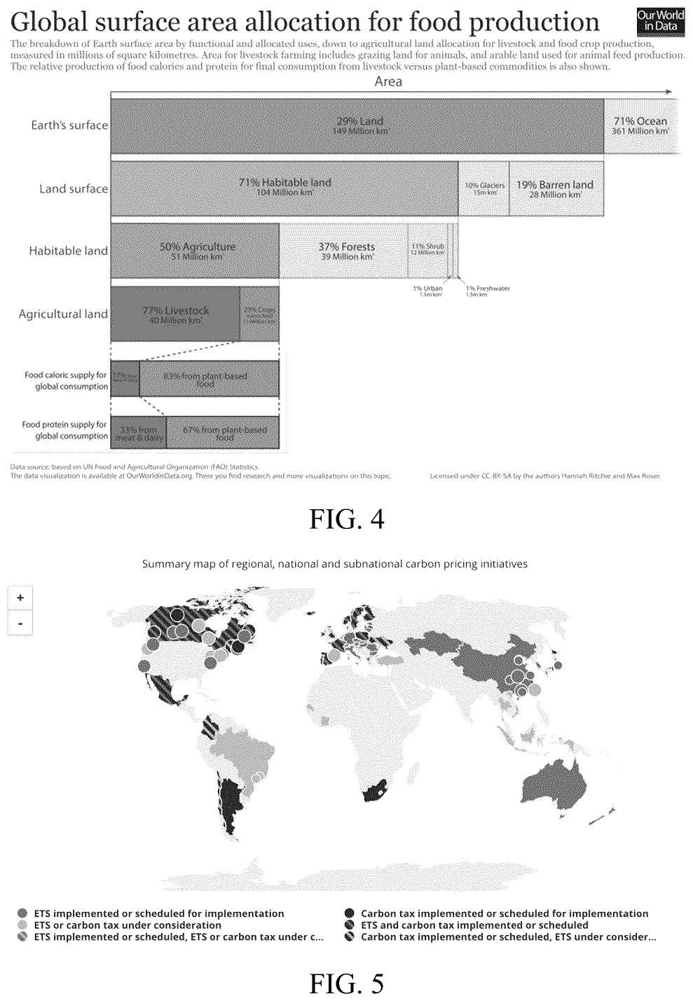

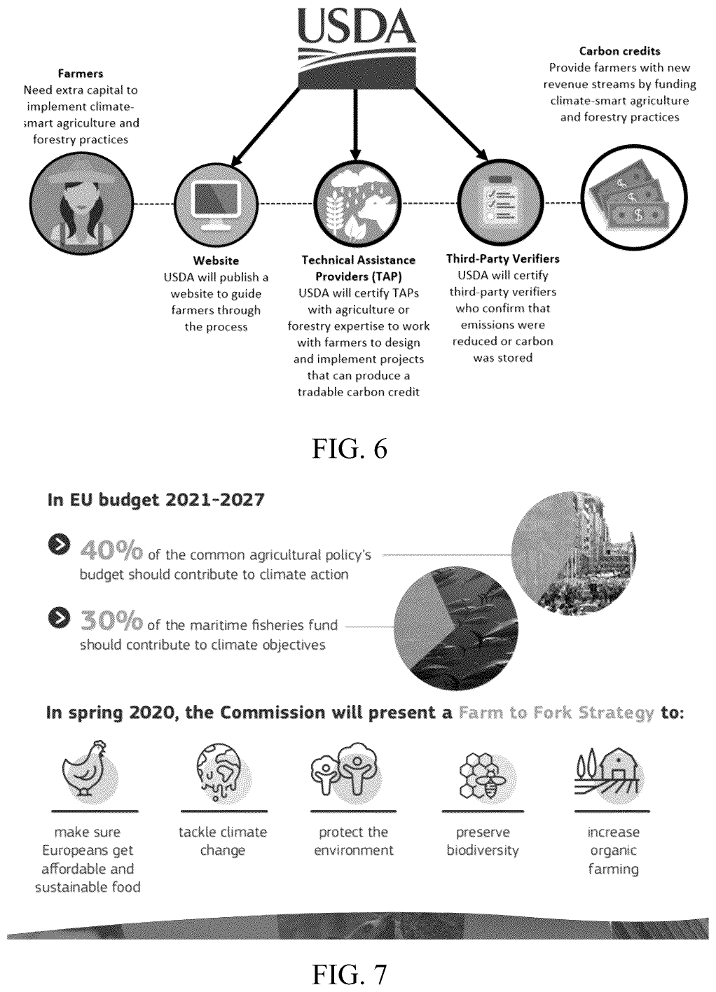

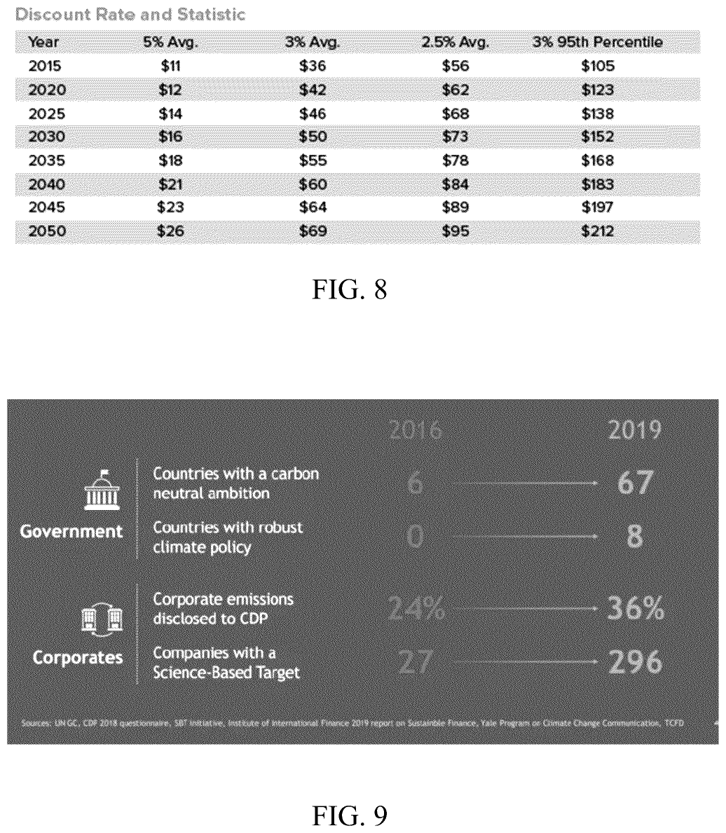

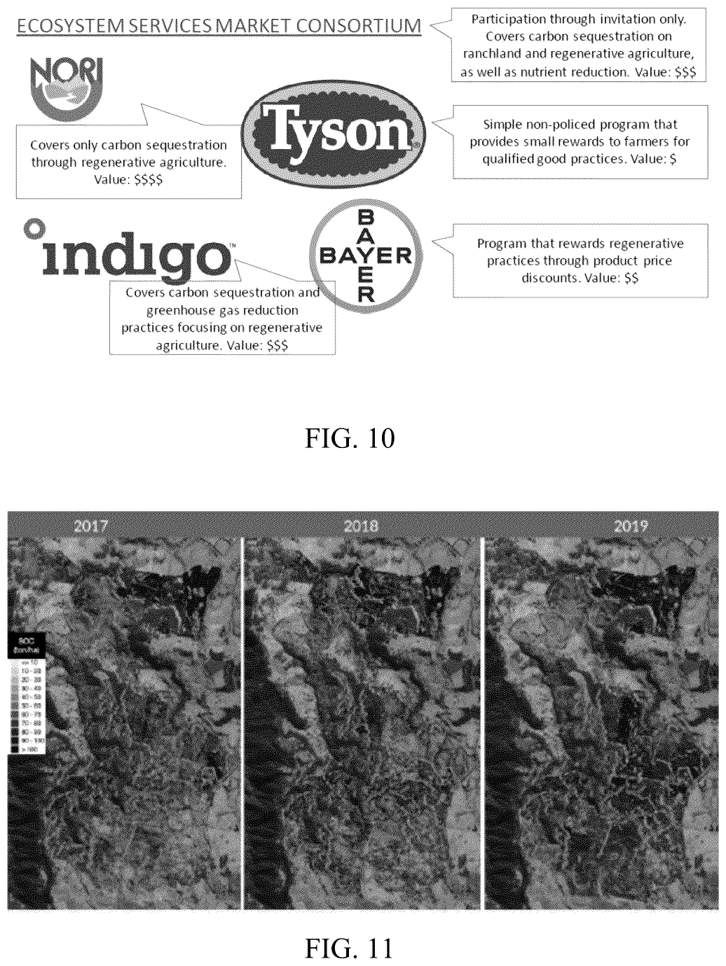

FIG. 1 is a block diagram of a system of an embodiment of the subject invention. Referring to FIG. 1, the system can include a platform (e.g., software code) that is stored on one or more (non-transitory) machine-readable media (e.g., one or more (non-transitory) computer-readable media), one or more processors that interact with the platform and the one or more machine-readable media, and a user interface (e.g., a graphical user interface (GUI)) that interacts with the platform, the processor(s) and/or the one or more machine-readable media. The user interface may also include a physical user interface (e.g., a display and one or more input devices such as a keyboard and a mouse), which may be separate from any physical user interface for the agriculture data management system or can share such a physical user interface with the agriculture data management system. The platform, processor(s), user interface(s), and/or machine-readable media can pull data from one or more regulatory and/or government sources (e.g., servers, websites, or other location where information on climate-change-related program benefits is available). The data pull can be based on the location of field blocks of the farm (or other agricultural location) for which the monetization is being performed. The platform, processor(s), user interface(s), and/or machine-readable media can interact directly (maybe via an application programming interface (API), but with no other computing device in between) with the local farm data management system or agriculture data management system at the farm (or other agricultural location) for which the monetization is being performed. The platform, processor(s), user interface(s), and/or machine-readable media can optionally interact with satellite soil organic carbon (SOC) imagery, agriculture SOC database(s), equipment software, accounting software, a livestock data management tool, crop insurance filing history, and/or remote sensing satellite imagery, all of which can be for the location for which the monetization is being performed. This optional interaction is represented by the dashed double arrows in FIG. 1. In FIG. 1, each double arrow (whether dashed or solid) can include an API via which the interaction takes place.

Systems and method of embodiments of the subject invention can be linked directly (e.g., via an API but with no other computing device in between) or indirectly with an agriculture data management system at the farm (or other agricultural location) for which the monetization is being performed. The systems and methods of embodiments of the subject invention are agnostic as to the type of agriculture data management system and can advantageously work with whatever agriculture data management system the agricultural site happens to use.

Different types of monetization opportunities can include, for example, carbon sequestration, nitrogen use reduction, phosphorous use reduction, soil nitrous oxide flux reduction, energy/fuel use reduction, enteric methane reduction, and reduction of methane from tailing ponds.

The platform of the system/method can investigate carbon sequestration by: examining practice change history of the farm or other setting by field block; examining satellite SOC change imagery; and/or reviewing agriculture SOC databases. The platform can also utilize the agriculture/farm data management tool, the United States Department of Agriculture (USDA) Farm Service Agency (FSA) and/or other regional equivalent (depending on the location), and/or crop insurance filings for practice change history. Satellite SOC imagery and/or agriculture SOC databases can also be used for carbon sequestration amount prediction, all or some of which may be integrated with the platform via respective APIs.

The platform of the system/method can investigate nitrogen use reduction by examining nitrogen-based fertilizer/manure/compost use history and/or the record of crop rotation. The platform can also utilize the agriculture/farm data management tool, the USDA FSA and/or other regional equivalent (depending on the location), and/or crop insurance filings for practice change history, all or some of which may be integrated with the platform via respective APIs.

The platform of the system/method can investigate phosphorous use reduction by examining phosphorous fertilizer use history and/or the record of crop rotation. The platform can also utilize the agriculture/farm data management tool, the USDA FSA and/or other regional equivalent (depending on the location), and/or crop insurance filings for practice change history, all or some of which may be integrated with the platform via respective APIs.

The platform of the system/method can investigate soil nitrous oxide flux reduction by examining nitrogen-based fertilizer/manure/compost use history, the record of crop rotation, and/or nitrous oxide inhibitor use history. The platform can also utilize the agriculture/farm data management tool, the USDA FSA and/or other regional equivalent (depending on the location), and/or crop insurance filings for practice change history, all or some of which may be integrated with the platform via respective APIs.

The platform of the system/method can investigate energy/fuel use reduction by examining farm energy use. The platform can also utilize equipment software or accounting software for energy/fuel use history, one or both of which may be integrated with the platform via respective APIs.

The platform of the system/method can investigate enteric methane reduction by examining feed or practice change history. The platform can also utilize a livestock data management tool for the agricultural location, which may be integrated with the platform via respective APIs.

The platform of the system/method can investigate reduction of methane from tailing ponds by examining practice change history and/or remote sensing satellite imagery. The platform can also utilize a livestock data management tool for the agricultural location and/or remote sensing satellite imagery, one or both of which may be integrated with the platform via respective APIs. FIG. 11 is an image of remote sensing satellite imagery showing SOC levels for 2017, 2018, and 2019 for a particular area.

Embodiments of the subject invention can utilize a model (e.g., a machine learning model or other type of optimization model) to optimize the monetization opportunities for climate-change-related program benefits for the agricultural site.

Related art systems include Indigo Ag's Terratron, Ecosystems Services Marketplace Consortium (ESMC), and Land O Lakes' Truterra. However, none of these are able to achieve the optimal monetization of embodiments of the subject invention. Terratron looks strictly at crop-based monetization that links only to Indigo's management program and is not blockchain-based. ESMC looks only at monetizing regenerative practices in row crops for its own program and does not provide a tool. Truterra looks only at row-crop practices and is not blockchain-based. ESMC and Truterra exclude animal husbandry completely even though it is a part of most agricultural operations. These systems do not investigate or obtain the data required to capture monetization and do not capture data at the level of granularity required to monetize. Instead, they provide a high-level dashboard without providing an ability to monetize any opportunity(ies).

Embodiments of the subject invention can assist users (e.g., farmers and other agricultural and forestry professionals) in optimizing monetization of climate-change-related program benefits, thereby gaining a piece of a large market. The platform can be provided on a use basis (i.e., use to optimize program benefits) and/or can be subscription based where the user must renew the ability to use the platform after a given period of time (e.g., a year).

The methods, processes, and platforms described herein can be embodied as code and/or data. The software code and data described herein can be stored on one or more machine-readable media (e.g., computer-readable media), which may include any device or medium that can store code and/or data for use by a computer system. When a computer system and/or processor reads and executes the code and/or data stored on a computer-readable medium, the computer system and/or processor performs the methods and processes embodied as data structures and code stored within the computer-readable storage medium.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that are capable of storing computer-readable information/data. Computer-readable media should not be construed or interpreted to include any propagating signals. A computer-readable medium of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

A greater understanding of the embodiments of the subject invention and of their many advantages may be had from the following examples, given by way of illustration. The following examples are illustrative of some of the methods, applications, embodiments, and variants of the present invention. They are, of course, not to be considered as limiting the invention. Numerous changes and modifications can be made with respect to the invention.

### Example 1

A grower used the platform of the systems/methods described herein to optimize monetization from soil carbon sequestration. The grower used the monetization process in a voluntary carbon market for the farm of 3,500 acres located in the United States. The process involved collecting the correct data from available sources (county, state, national, and international levels) and having the information third-party verified before getting to the point of sale in the voluntary carbon market. This resulted in an increased monetization of about $300,000 from soil carbon sequestration.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

1. A system for optimizing monetization opportunities for climate-change-related program benefits for an agricultural site, the system comprising:
a processor; and
a machine-readable medium in operable communication with the processor and an agriculture data management system of the agricultural site, the machine-readable medium having instructions stored thereon that, when executed by the processor, perform the following steps:
collecting, from at least one regulatory or government information source, first data about the climate-change-related program benefits, the climate-change-related program benefits being based on the geographical location of the agriculture site;
collecting, from the agriculture data management system, second data about the agricultural site;
analyzing the first data and the second data to determine the climate-change-related program benefits for which the agricultural site is eligible;
running an optimization process on the first data and the second data to determine an optimum combination of climate-change-related program benefits for the agricultural site to maximize monetization of available climate-change-related program benefits; and
utilizing blockchain to publicly post transactions from the optimum combination of climate-change-related program benefits.

2. The system according to claim 1, the climate-change-related program benefits comprising benefits related to carbon sequestration.

3. The system according to claim 1, the climate-change-related program benefits comprising benefits related to nitrogen use reduction.

4. The system according to claim 1, the climate-change-related program benefits comprising benefits related to phosphorous use reduction.

5. (canceled)

6. The system according to claim 1, the climate-change-related program benefits comprising benefits related to energy use reduction, fuel use reduction, or both.

7. The system according to claim 1, the climate-change-related program benefits comprising benefits related to enteric methane reduction.

8. The system according to claim 1, the climate-change-related program benefits comprising benefits related to reduction of methane from tailing ponds.

9. (canceled)

10. The system according to claim 1, further comprising a display and a graphical user interface (GUI) via which a user can view results and enter information.

11. The system according to claim 1, wherein the second data is collected from satellite soil organic carbon (SOC) imagery of the agricultural site, crop insurance filings of the agricultural site, an agriculture soil organic carbon (SOC) database, equipment software of the agricultural site, accounting software of the agricultural site, a livestock data management tool of the agricultural site, and/or remote sensing satellite imagery of the agricultural site.

12-17. (canceled)

18. The system according to claim 1, wherein the first data about the climate-change-related program benefits comprises information about county-level climate-change-related program benefits.

19. The system according to claim 1, wherein the first data about the climate-change-related program benefits comprises information about state-level climate-change-related program benefits.

20. The system according to claim 1, wherein the first data about the climate-change-related program benefits comprises information about national-level climate-change-related program benefits.

21. The system according to claim 1, wherein the first data about the climate-change-related program benefits comprises information about international-level climate-change-related program benefits.

22. The system according to claim 1, wherein the system communicates with a carbon market.

23. The system according to claim 1, wherein the system comprises at least one application programming interface (API) to obtain the first data and/or second data from each source, respectively.

24. The system according to claim 1, wherein the at least one regulatory or government information source comprises a regulatory or government server, a regulatory or government website, or both.

25. The system according to claim 1, wherein the instructions when executed by the processor further performing the following step:
initiating a practice change impact dashboard in which a user can utilize a physical user interface to provide input and view different scenarios based on the provided input via a graphical user interface on a display of the system.

26. A method for optimizing monetization opportunities for climate-change-related program benefits for an agricultural site, the method comprising:
collecting, from at least one regulatory or government information source, first data about the climate-change-related program benefits, the climate-change-related program benefits being based on the geographical location of the agriculture site, wherein the collecting of the first data is performed by a processor in operable communication with an agriculture data management system of the agricultural site;
collecting, by the processor from the agriculture data management system, second data about the agricultural site;
analyzing, by the processor, the first data and the second data to determine the climate-change-related program benefits for which the agricultural site is eligible;
running, by the processor, an optimization process on the first data and the second data to determine an optimum combination of climate-change-related program benefits for the agricultural site to maximize monetization of available climate-change-related program benefits; and
utilizing, by the processor, blockchain to publicly post transactions from the optimum combination of climate-change-related program benefits.

27. (canceled)
